(19) United States
(12) Patent Application Publication
(10) Pub. No.: US 2003/0173009 A1
(43) Pub. Date: Sep. 18, 2003

(54) Identification marker for use in a head cover of a golf club attached by magnetic force

(76) Inventor: Jin-Tae Choe, Seoul (KR)

Correspondence Address: John P. White, Cooper & Dunham LLP, 1185 Avenue of the Americas, New York, NY, 10036, US

(21) Appl. No.: 10/172,671

(22) Filed: Jun. 14, 2002

(30) Foreign Application Priority Data
Mar. 12, 2002 (KR) 2002-13283

(51) Int. Cl. B65D 65/02; B65D 85/00; G09F 3/18

(52) U.S. Cl. 150/160; 40/661.01

(57) ABSTRACT

Disclosed is an identification member used for a head cover of a golf club, in which a fixed member is fixed on the surface of the head cover and an identification member having the identification number or character is attached to the fixed member. The fixed member is made of magnetic material or metallic material, and the identification member is made of magnetic material or metallic material so as to be attracted by the fixed member by a magnetic force. The identification character or the name of user or owner of the golf club can be inscribed on the identification member. The identification member can be attached to or detached from the head cover easily, and the convenience in identifying the golf club is provided.

### BACKGROUND OF THE INVENTION

1. Technical Field

The present invention relates to an identification marker for use in a head cover of a golf club, wherein the identification member for identifying the user or the owner of the golf club is detachably fixed to the head cover by a magnetic force, so that the kind of the golf club can be identified easily and the identification member can be attached to and detached from the head cover conveniently.

2. Description of the Related Art

Golf is a kind of popular sports that can be enjoyed in a field, which is a game to strike a golf ball toward a hole at a distant position in order to put the golf ball into the hole in a striking number as smaller as possible.

The golf club used in the golf is comprised of a head, a shaft and a grip, and is classified according to the usage thereof and the flying distance of the golf ball into a wood, an iron and a putter. Further, various kinds of golf clubs constitutes a set of golf clubs, which is constituted in consideration of the user's inclination, the flying distance, and etc.

Meanwhile, the golf clubs are kept in a golf bag with their heads upward, and are moved while being kept in such a status. In that situation, if the golf bag falls down unexpectedly or the golf bag is shaken with the movement thereof during the game, the golf clubs may break by the collision between the golf clubs. Thus, in order to prevent the breakdown of the head or the shaft of the golf clubs, a head cover for protecting the head is wrapped on the head of the golf club.

As known publicly, the golf clubs can be identified by the identification mark such as numbers, characters or colors, and such an identification mark is inscribed on the head of the golf club. For example, the driver is classified to the number one through five, the iron to one through nine. The identification mark such as the identification number or the identification character is inscribed on the head. Meanwhile, as the head cover covers the head of the golf club, the identification mark is hidden by the head cover. Thus, another identification mark for identifying the golf club should be provided on a side of the head cover so that the user can identify the golf club.

As a separate head cover for protecting the golf club is wrapped on the golf club, the collision between the golf clubs is prevented, and the golf club to be used can be identified easily with the identification mark provided on the head cover, to be drawn out of the golf back easily. The identification mark of the head cover is made by embroidery or printing on the head cover.

However, according to the conventional method, one identification mark of the head cover can be used only one golf club, so the manufacturer of the identification mark has the disadvantage to manufacture and then provide the identification marks corresponding to the produced golf clubs according to the request of a seller, and the user of the golf club has the disadvantage to buy a new head cover when he/she purchases a new golf club or changes a golf club to a new one if he/she does not have a head cover with the identification mark corresponding to the new golf club.

To solve such a problem, an improved head cover 2 has been proposed as shown in FIG. 1, in which an identification marker 4 having the identification mark such as the identification numbers or characters can be attached and detached.

According to such an identification marker 4, an adhesive material 3 such as a Velcro™ fastener is fixed on the surface of the head cover 2, and an identification member 1 having a size corresponding to the adhesive material 3 is detachably attached to the adhesive material 3. For such a construction, an additional adhesive material that can be attached to and detached from the adhesive material 3 is fixed on the lower side of the identification member 1.

Accordingly, a proper identification member 1 is selected according to the kind of the golf club wrapped by the head cover 2, and then the identification marker 4 is attached on the head cover 2. According to such a construction, there is an advantage that one head cover 2 can be used for plural kinds of golf clubs because the identification member 1 can be substituted to other ones.

However, although the identification marker 4 attached by the Velcro™ fastener has a great advantage in comparison with the conventional type identification mark fixed directly on the head cover, there is a problem that the appearance of the head cover 2 is bad due to the irregular surface of the head cover. It is because the identification marker 4 is attached to protrude at the surface of the head cover 2 as shown in FIG. 1, which is caused by the characteristic of the adhesive material 3 itself.

In particular, since the adhesive material 3 protrudes from the head cover 2, even a slight inexactness of the attached position of the adhesive material 3 to the identification member 1 may cause damage to the cloth of a user since the Velcro™ fastener may be contacted with the clothes of the user. Further, dust or a thread can adhere to the Velcro fastener, which gives a bad appearance.

### SUMMARY OF THE INVENTION

The present invention has been proposed to overcome the above-described problems, and accordingly, an object of the present invention is to provide an identification marker used for inscribing the identification number, the identification character, the trademark of a manufacturer, or the owner of the golf club, which can be attached by a magnetic force so as to be attached and detached easily and give a good appearance.

In order to achieve the above-described object, the present invention provides an identification marker for use in a head cover of a golf club, comprising: a fixed member being fixed to the head cover, the fixed member being made of a material selected from a magnetic material and a metallic material; and an identification member being made of a material selected from the magnetic material and the metallic material so as to be attracted by the fixed member by a magnetic force, the identification member having an identification mark on an outside exposed surface thereof.

The fixed member may be accommodated and fixed in a recess formed on the head cover. The fixed member may be fixed on the head cover by using an adhesive agent. The fixed member can have a protrusion and the identification member can have a recess corresponding to the protrusion of the fixed member.

The fixed member may be disposed between an outer cover and an inner cover of the head cover which are then sewed together thereby fixing the fixed member between the outer cover and inner cover of the head cover.

Also, the fixed member is fixed on an inner side of an outer cover of the head cover by using a resin film sheet which is adhered thereto through high-frequency waves.

The identification member has a coated layer formed on the surface having the identification mark.

The present invention also provides an identification marker for use in a head cover of a golf club, comprising: a tag attached to the head cover; a fixed member being fixed on the tag, the fixed member being made of a material selected from a magnetic material and a metallic material; and an identification member being made of a material selected from the magnetic material and the metallic material so as to be attracted by the fixed member by a magnetic force, the identification member having an identification mark on an outside exposed surface thereof.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 illustrates the construction of a conventional head cover of a golf club.

FIG. 2 is a perspective view of a golf club having an identification marker of a head cover, according to an embodiment of the present invention.

FIGS. 3A to FIG. 3F are sectional views showing the attached/detached status of the fixed member and the identification member of the identification marker used for the head cover of the golf club according to the present invention.

FIG. 4 is a perspective view of the identification marker for use in the head cover of the golf club, according to another embodiment of the present invention.

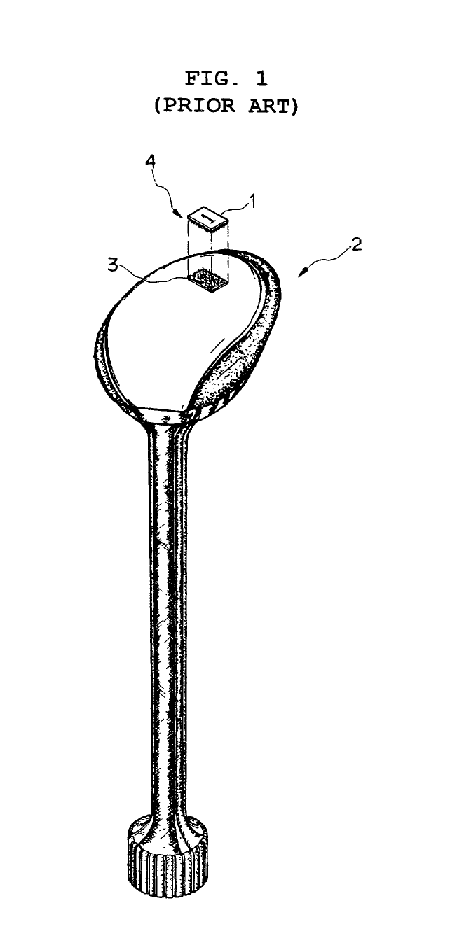

### DETAILED DESCRIPTION OF THE PREFERRED EMBODIMENTS

Hereinafter, preferred embodiments of the present invention will be described in detail with reference to the accompanying drawings.

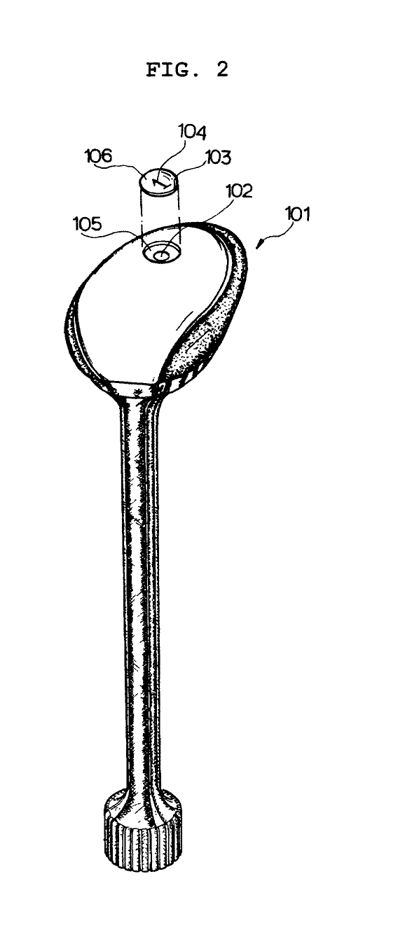

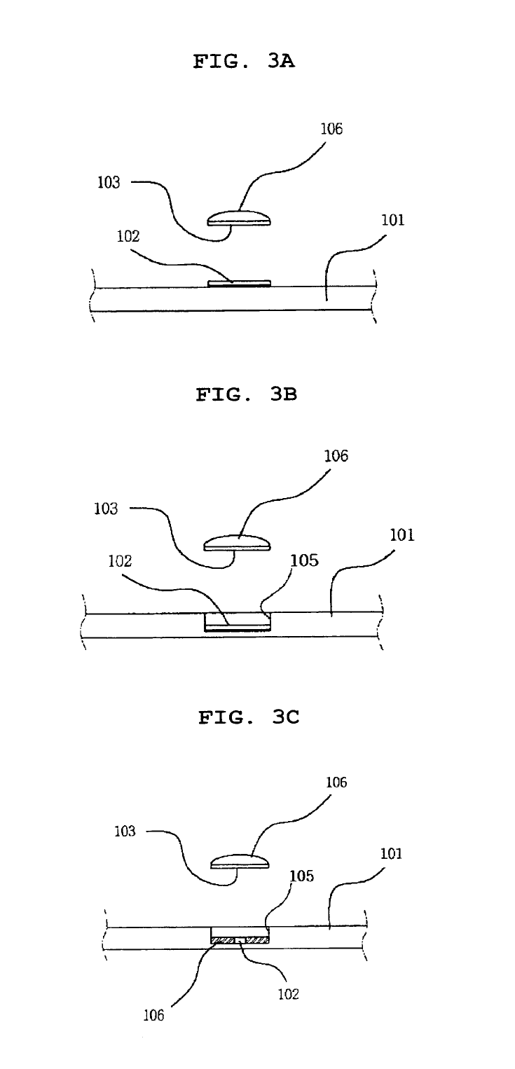

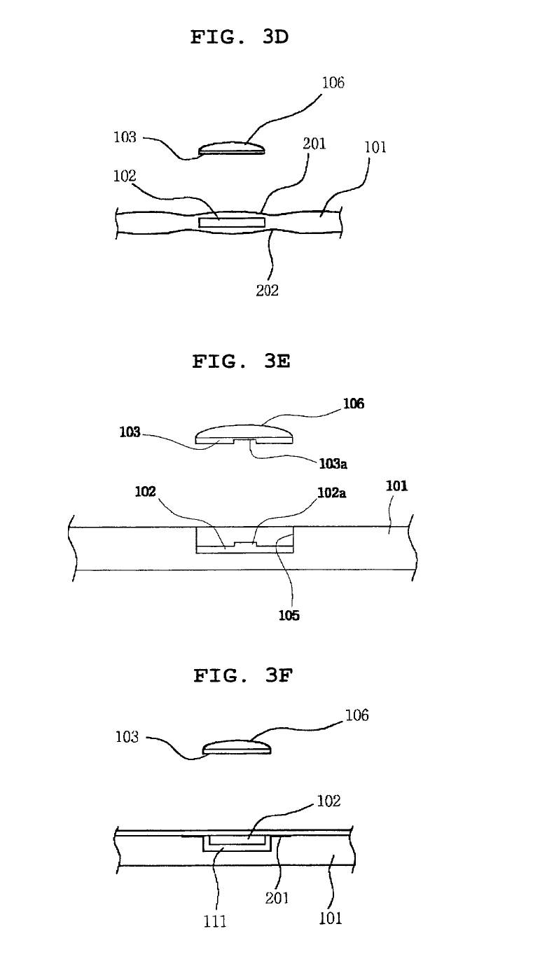

The head cover 101 shown in FIG. 2 is only the example of various head covers, and the kind or the shape of the head cover 101 is not limited in the present invention. As shown in FIG. 3A, a fixed member 102 made of magnetic material or metallic material is fixed on the surface of the head cover 101 with an adhesive agent. An identification member 103 is detachably attached to the fixed member 102 by a magnetic force. The identification member 103 is made of a magnetic material or a metallic material, so as to be attached to the fixed member 102 by the magnetic force between the fixed member 102 and the identification member 103.

An identification mark 104 such as the number or the character of the golf club or the trademark of the manufacturer of the golf club can be inscribed on the upper portion of the identification member 103. Furthermore, it is possible to prepare a space for writing an identification character such as the name of the user. It is preferable that one of the both sides on which the identification mark 104 is inscribed is coated with synthetic resin such as epoxy so as to form a coated layer 106, which can prevent the deletion of the identification mark 104 caused by the frequent use or contact.

Here, if the fixed member 102 is made of a magnetic material, the identification member 103 is preferably made of a metallic material, and the reverse is possible. Further, if all of the fixed member 102 and the identification member 103 are made of the magnetic material, the pole of the surface of the fixed member 102 has to be reverse of that of the identification member 103 so that the identification member 103 is attached to the fixed member 102 by the attracting magnetic force.

That is, the constitution of the fixed member 102 and the identification member 103 can be any type if they can be attached to each other with the attracting magnetic force. In the meantime, the strength of the magnetic force between the fixed member 102 and the identification member 103 should be set to a degree that the user can detach easily.

Accordingly, as the fixed member 102 is fixed on the surface of the head cover 101, even when the surface of the identification member 103 is made of urethane or synthetic resin, the identification member 103 can be attached to the fixed member 102.

Meanwhile, as shown in FIG. 3B, a recess 105 of a predetermined size is formed on the surface of the head cover 101, which can be formed when a part of the head cover 101 is made of the urethane or the epoxy, not of cloth. The recess 105 is formed to have a size proper to accommodate the fixed member 102 and have a predetermined depth while the head cover 101 is being manufactured. The fixed member 102 is fixed in the recess 105 as shown in FIG. 3B so that the fixed member 102 does not protrude from the surface of the head cover 101, which provides a clean appearance.

Here, it is preferable that the fixed member 102 is thinner than the depth of the recess 105 so that the fixed member 102 is located at the inner area of the recess 105. And it is also preferable that the identification member 103 attached to the fixed member 102 is thin enough to be fully accommodated in the recess 105. Then, while the identification member 103 and the fixed member 102 is attached to each other, the identification member 103 is not moved sideward or detached by the frequent use or the frequent contact of the user.

Furthermore, as the identification member 103 is inserted into the recess 105 as described above, the visual effect that the identification member 103 is assumed to be formed integrally with the surface of the head cover 101 can be achieved. Therefore, the identification member 103 can be manufactured to a variety of shapes and forms, to make the appearance of the head cover 101 graceful.

Moreover, as shown in FIG. 2 and FIG. 3C, the fixed member 102 is manufactured to have a minimum size for giving a magnetic force enough to attach the identification member 103, and a predetermined amount of liquid synthetic resin 109 such as epoxy is filled up in the recess 105. As the synthetic resin 109 becomes solid state, the fixed member 102 is fixed steadfastly, and then the identification member 103 is attached to the fixed member 102 by the magnetic force. Thus, the minimum amount of magnetic material is used to reduce manufacturing costs, and the identification member 103 is not detached easily from the recess 105.

Further, as shown in FIG. 3D, it is possible that the fixed member 102 made of magnetic material or metallic material can be disposed between the outer cover 201 and the inner cover 202 of the head cover 101, which are then sewed together thereby fixing the fixed member between the outer cover 201 and inner cover 202 of the head cover 101. And as shown in FIG. 3E, it is possible that a protrusion 102a and a recess 103a are formed on the attached parts of the fixed member 102 and the identification member 103 respectively, by which the attachment or detachment becomes easier.

Preferably, as shown in FIG. 3F, the fixed member 102 can be fixed on an inner side of an outer cover 201 of the head cover. A resin film sheet 111, like a PVC sheet, can be used instead of adhesives. High-frequency waves may be used for melting and adhering the resin film sheet to the inner side of the outer cover 201 of the head cover thereby fixing the fixed member 102 thereon.

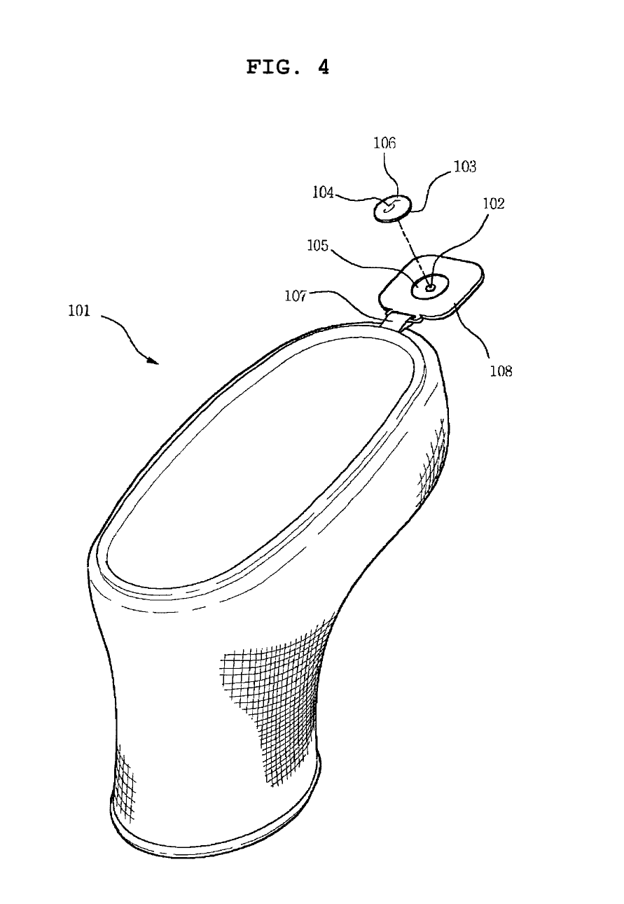

Meanwhile, FIG. 4 shows the identification marker according to another embodiment of the present invention. As shown in FIG. 4, a tag 108 is attached on a portion of the head cover 101 by a ring 107, and the fixed member 102 and the identification member 103 of identification marker shown in FIGS. 3A to 3E for use in the head cover according to the present invention can be fixed on a portion of the tag 108.

According to the present invention, the fixed member is fixed on the surface of the head cover and the identification member having the identification number is attached to the fixed member by the magnetic force. The identification character or the name of the user or the owner can be inscribed on the identification member. Thus, the identification member can be attached to or detached from the head cover, which provides convenience in identifying the golf club. In particular, a recess is formed while the head cover is being manufactured and the fixed member and the identification member are accommodated in the recess, so the detachment of the identification member is prevented even by the frequent use and contact, and a graceful appearance can be achieved by the visual effect that the identification member and the head cover look as if they are formed integrally.

Although the preferred embodiments of the present invention has been described, it will be understood by those skilled in the art that the present invention should not be limited to the described preferred embodiments, but various changes and modifications can be made within the spirit and the scope of the present invention. Accordingly, the scope of the present invention is not limited within the described range of the following claims.

What is claimed is:

1. An identification marker for use in a head cover of a golf club, comprising:
a fixed member being fixed to the head cover, the fixed member being made of a material selected from a magnetic material and a metallic material; and
an identification member being made of a material selected from the magnetic material and the metallic material so as to be attracted by the fixed member by a magnetic force, the identification member having an identification mark on an outside exposed surface thereof.

2. The identification marker of claim 1, wherein the fixed member is accommodated and fixed in a recess formed on the head cover.

3. The identification marker of claim 1, wherein the fixed member is fixed on the head cover by using an adhesive agent.

4. The identification marker of claim 1, wherein the fixed member is fixed between an outer cover and an inner cover of the head cover which are sewed together.

5. The identification marker of claim 1, wherein the fixed member is fixed on an inner side of an outer cover of the head cover by using a resin film sheet which is adhered thereto through high-frequency waves.

6. The identification marker of claim 1, wherein the fixed member has a protrusion and the identification member has a recess corresponding to the protrusion of the fixed member.

7. The identification marker of claim 1, wherein the identification member has a coated layer formed on the surface having the identification mark.

8. An identification marker for use in a head cover of a golf club, comprising:
a tag attached to the head cover;
a fixed member being fixed on the tag, the fixed member being made of a material selected from a magnetic material and a metallic material; and
an identification member being made of a material selected from the magnetic material and the metallic material so as to be attracted by the fixed member by a magnetic force, the identification member having an identification mark on an outside exposed surface thereof.
